(19) United States
(12) Patent Application Publication
(10) Pub. No.: US 2017/0140463 A1
(43) Pub. Date: May 18, 2017

(54) SYSTEM AND METHOD FOR PURCHASE OF RESIDENTIAL HOME OR SHARES THEREIN WITH A LIFETIME RIGHT OF OCCUPANCY

(71) Applicant: Paul A. Gellert, New York, NY (US)

(72) Inventor: Paul A. Gellert, New York, NY (US)

(21) Appl. No.: 14/941,565

(22) Filed: Nov. 14, 2015

(51) Int. Cl. G06Q 40/06

(52) U.S. Cl. CPC G06Q 40/06; G06Q 50/16

(57) ABSTRACT

A method for purchasing a residential home or shares therein while providing a youngest leasee a lifetime right of occupancy, the method steps comprising determining a fair market value of the residential home or shares therein, determining any mortgages or liens held against the residential home or shares therein, determining the age and gender of the youngest leasee, calculating a remaining life expectancy duration for the youngest leasee, calculating a life estate value of the residential home or shares therein based on the age of the youngest leasee, calculating closing costs associated with the purchase of the residential home or shares therein, creating a housing expense trust, calculating a pre-funding asset amount needed to fund the housing expense trust, calculating a pre-tax unrestricted amount as a monetary consideration for the purchase of the residential home or shares therein, executing a contract that executes the purchase of the residential home or shares therein for the monetary consideration, creates a lifetime lease for the youngest leasee in the residential home or shares therein and provide for the payment of annualized housing fees associated with the residential home or shares therein from assets within the housing expense trust, and funding the housing expense trust with funds equal to the calculated pre-funding asset amount.

### FIELD OF THE INVENTION

This disclosure relates generally to a system and method for a buyer to purchase a residential home or shares therein while providing one or more defined leasees a lifetime right of occupancy in the residential home.

### BACKGROUND

The most common way for homeowners age of 62 or older, who do not qualify for a traditional home mortgage or home equity loan for any reason such as a lack of qualifying income, to realize cash from equity established in a residential home or shares therein is through a reverse mortgage. A reverse mortgage is a loan against a residential home that does not need to be repaid as long as the borrower remains in that residential home. With a reverse mortgage, equity in a residential home may be converted into cash without ever having to move out of that residential home or even having to make monthly loan payments. Typically, a reverse mortgage need not be repaid until the residential home owner dies, sells the home, or permanently moves out of that residential home.

However, reverse mortgages have several limitations which may restrict a homeowner's ability to use this instrument to access the equity in their residential home. A reverse mortgage is a type of mortgage that is funded with an extremely low loan to value limitation and whose interest charges consume additional equity in a residential home or shares therein.

Also, reverse mortgages are highly regulated by the Federal Government. Generally, to be eligible for a reverse mortgage, the applicant must have ownership of the residential home to be mortgaged and that residential home must be the owner's primary residence.

Also, reverse mortgages are restricted to specific types of residential homes, namely single family homes, FHA approved condominiums, and townhouses. Cooperative as well as non-FHA approved condominium do not qualify.

Furthermore, the funds available through a reverse mortgage depend on the age of the residential home owner, the appraised value of the residential home and the current interest rates. In the case of a government sponsored reverse mortgage, the Federal Housing Authority sets the limit on available funds, the current limit being $625,000. Therefore, a large percentage of homeowners age 62 and older may not satisfy all the legal requirements of a reverse mortgage.

Moreover, as with all other mortgages, the borrower must satisfy defined financial and credit requirements to qualify for a reverse mortgage. Moreover, the borrower may be evicted from their residential home for defaulting on a reverse mortgage. As such, in those cases where the equity of the homeowner is already encumbered, reverse mortgage financing opportunities may be severely restricted, and in some cases, made impossible by the laws or rules governing reverse mortgages.

The percentage of homeowners age 62 and older carrying mortgage debt has increased from 22 to 30 percent from 2001 to 2011. Consumers age 62 and older also owe larger balances on their mortgages than those same consumers did a decade ago. From 2001 to 2011, the medium amount older homeowners owed on mortgages increased 82 percent, from approximately $43,400 to $79,000. Therefore, a large percentage of homeowners ages 62 and older who have existing mortgage debt may not satisfy all the financial and credit requirements of a reverse mortgage.

Another common method of retrieving equity in a residential home or shares therein while still occupying that residential home is a life estate. In a life estate, the seller of the estate retains no residual interest in the estate but does receive a lifetime lease in the residential home comprising the estate. The life estate owner retains control of the residential home until he or she dies but is not limited to the rights of a tenant. As a result, conflicts may arise as to the sale by the buyer of future interest in the estate by the buyer. Moreover, the life estate may be susceptible to tax recapture issues.

Therefore, although homeowners age 62 and older may have built up equity in their homes, converting that equity in cash without actually selling and giving up occupancy of that home is often not an available or viable option.

### BRIEF SUMMARY

The present invention seeks to solve the above-described problems by disclosing a system and method for purchasing a residential home or shares therein while providing a defined leasee a lifetime right of occupancy in the purchased residential home. Specifically, the present invention discloses a method for purchasing a residential home or shares therein while providing a youngest leasee a lifetime right of occupancy, the method steps comprising determining a fair market value of the residential home or shares therein, determining any mortgages or liens held against the residential home or shares therein, determining the age and gender of the youngest leasee, calculating a remaining life expectancy duration for the youngest leasee, calculating a life estate value of the residential home or shares therein based on the age of the youngest leasee, calculating closing costs associated with the purchase of the residential home or shares therein, creating a housing expense trust, calculating a pre-funding asset amount needed to fund the housing expense trust, calculating a pre-tax unrestricted amount as a monetary consideration for the purchase of the residential home or shares therein, executing a contract that executes the purchase of the residential home or shares therein for the monetary consideration, creates a lifetime lease for the youngest leasee in the residential home or shares therein and provide for the payment of annualized housing fees associated with the residential home or shares therein from assets within the housing expense trust, and funding the housing expense trust with funds equal to the calculated pre-funding asset amount.

### BRIEF DESCRIPTION OF THE DRAWINGS

This disclosure is further described in the detailed description that follows, with reference to the drawings, in which:

FIG. 1 is a block diagram illustrating the system and method for purchasing a residential home or shares therein according to an embodiment of the present invention.

FIG. 2 is an exemplary depiction of a Period Life Table as implemented in the system and method for purchasing a residential home or shares therein according to an embodiment of the present invention.

FIG. 3 is an exemplary depiction of a Life Estate or Remainder table implemented in the system and method for purchasing a residential home or shares therein according to an embodiment of the present invention.

### DETAILED DESCRIPTION

As discussed above, a preferred embodiment of a method for purchasing a residential home or shares therein with a lifetime right of occupancy in the purchased residential home or shares therein is disclosed herein.

A residential home may include buildings and other structures as well as the rights and interests in those buildings and other structures. Examples of residential homes as applied in the present invention include single family homes, condominiums, cooperatives, townhouses, multi-family units and land. It will be obvious to a person of reasonable skill in the art that other types of residences may also be included as residential home for purposes of the present invention.

As a simplified explanation of the different types of residential homes, a single family home is built on a single lot of land with no shared walls. There may also be an attached or detached garage. A condominium is a single unit within a larger building or community. The condominium units often share walls with each other. A condominium homeowner association is often implemented, the associate establishing and requiring the payment of monthly or yearly dues. Ownership is held in the actual space within each unit. A cooperative is similar to a condominium but differs in the way title is held. In a cooperative, title in the entire building is held by everyone. As a result, the responsibility for the building or community is also shared by everyone. A townhouse is a hybrid between a condominium and a single family home. Townhouses often have multiple floors with one or two shared walls. They generally are larger than a condominium but smaller than a single family home. They may also implement a home owners association or a joint maintenance agreement in order to share maintenance costs. A multifamily home can range from a duplex to a fourplex with anything more being defined as a commercial space. Like a townhouse, a multifamily home is a hybrid between a single family home and a condominium. Each unit of a multifamily home has its own entrance. The difference between the units within a multifamily home and a condominium is that a multifamily home unit cannot be purchased individually. Rather, there is a single owner for all of the units within the multifamily home.

For purposes of the present invention, a residential home or shares therein may include any of the above-described residential properties with the further limitation that the residential home or shares therein has a quantifiable amount of existing equity.

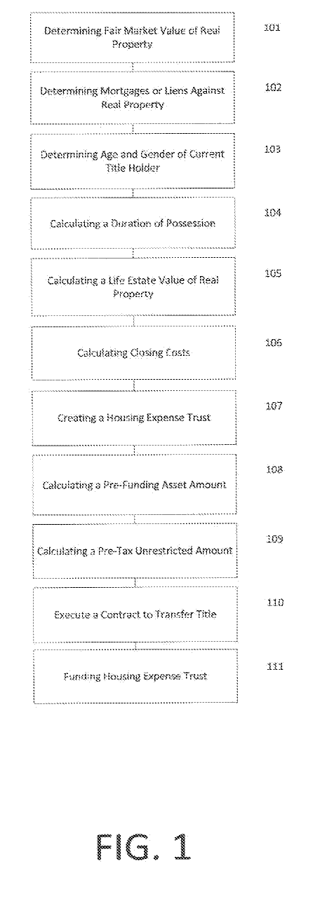

In FIG. 1, a block diagram illustrating the system and method for purchasing a residential home or shares therein according to an embodiment of the present invention is illustrated. As shown in FIG. 1, the method of the present invention is initiated in step 101 by determining a fair market value of a residential home or shares therein to be purchased according to an embodiment of the present invention.

The fair market value of the residential home or shares therein is the price that it will sell for on the open market, the transaction being between a willing seller and a willing buyer. Many factors may be considered in determining the fair market value of a residential home or shares therein, including comparable sales, market trends, unusual circumstances, comparative market analysis and appraisals.

Comparative sales involve knowing the sale price of similar residential homes that have sold in a defined period prior to the determination of the fair market value. Adjustments in price for differences in size, location and condition of a similar residential home must also be considered. Market trends involve the application of the laws of supply and demand to the fair market value. In a seller's market, the supply of residential homes is lower than the demand for that residential home by qualified buyers. In this case, the fair marker value of the residential home or shares therein would be higher. In a buyer's market, the supply of residential homes is greater than the demand for those residential homes by qualified buyers. In this case, the fair market value of the residential homes or shares therein would be lower. Fair market value reflects the worth of the residential home or shares therein under normal circumstances in which a seller and buyer freely negotiate a transfer of ownership. However, unusual circumstances can affect the fair market value. For example, a bank-owned home, may be listed for sale at considerably less than similar homes in the same neighborhood because the bank wants to sell the home quickly to recoup its money, also known as a return on equity sale. Owners of other homes in the same neighborhood as a bank's return on equity sale might have to lower their asking price if they want to sell their home under those conditions.

A licensed real estate appraiser will provide a formal determination of the fair market value of a residential home or shares therein, the appraisal including a legal description of the home, its measurements, any recent improvements, zoning and permits. Of course, a person of reasonable skill in the art may know of and take into account other factors relevant to the determination of a fair market value for a particular type of residential home or shares therein.

Once a fair market value has been determined, the method of the present invention in step 102 then determines if there are any mortgages or liens held against the residential home or shares therein. A mortgage is a security that a lender holds in support of a loan for the purchase of the residential home or shares therein. The mortgage is an interest in the residential home or shares therein held by the lender as protection in case the borrower should fail to pay back the loan.

A lien is a notice attached to the residential home or shares therein informing everyone that the owner owes a creditor money. Prior to selling the residential home or shares therein and giving clear ownership to a buyer, the owner must pay off the lien. There are several types of liens which may be attached to a residential home or shares therein.

A judgement lien is placed on a residential home or shares therein after a creditor wins a court judgement against the owner. Other types of liens do not necessarily require a lawsuit, these liens include tax liens, IRS liens, child support liens, and mechanic liens. A tax lien may be instituted by the government if taxes on a residential home or shares therein have not been paid. The government may have the residential home or shares therein sold to satisfy the outstanding taxes. A tax lien takes priority over all other mortgages or liens, even if initiated later than any other liens. An IRS lien may be instituted by the Internal Revenue Service if the owner of a residential home fails to pay passed due taxes after having received a notice from the IRS. This type of lien is often used if the owner is unemployed, self-employed, or sporadically employed such that the IRS would have trouble attaching regular wages from that owner. A child support lien may be instituted if the owner of a residential home or shares therein has not paid required child support or alimony. A child support lien stays in effect against the residential home or shares therein until either the owed child support or alimony is paid, the residential home or shares therein is sold or refinanced, or the recipient of the child support or alimony forces a lien sale. Lastly, a mechanic's lien may be instituted by a contractor if an owner of a residential home or shares therein fails to pay for work done by the contractor on the residential home or for construction materials used in conjunction with the residential home. The contractor must then sue to enforce the mechanic's lien and, if the contractor wins the lawsuit, he can force the sale of the residential home or shares therein to satisfy what is due the contractor.

Once any mortgages and liens against the residential home or shares therein have been determined, the method of the present invention in step 103 then determines the age and gender of the youngest leasee who will have a lifetime right of occupancy in the residential home or shares therein.

Once the age and gender of the youngest leasee is determined, method of the present invention in step 104 then calculates the remaining life expectance of the youngest leasee during which time the youngest leasee will retain a lifetime right of occupancy after ownership of the residential home or shares therein have transferred to the buyer. Of course, the actual term of occupancy by the youngest leasee may be less than, equal to or greater than the calculated remaining life expectancy. However, the calculated remaining life expectancy does provides an estimate of how long annual expenses associated with the residential home or shares therein will need to be financed after ownership has transferred to the buyer. As will be discussed further below, these annual housing expenses will be financed by a housing expense trust established and prefunded by the seller of the residential property or shares therein, the prefunding amount being sufficient to cover the annual housing expenses associated with the residential home or shares therein over the remaining life expectancy of the youngest leasee.

The remaining life expectancy is calculated by estimating remaining life expectancy of the youngest leasee and multiplying that estimate by a pre-defined life expectancy factor. The estimated remaining life expectancy is determined using A Period Life Table referencing the current age and gender of the youngest leasee. The product of the estimated remaining life expectancy and the pre-defined life expectancy factor is then rounded upward to provide a final value that defines the estimated duration of the housing expense trust. The pre-defined life expectancy factor is set to numerical value that will bring the expected term of the housing expense trust close to one hundred years.

Once the remaining life expectancy has been calculated, the method of the present invention in step 105 then calculates the life estate value of the residential home or shares therein based on the current age of the youngest leasee.

A life estate is an interest in a residential home that gives the life estate owner, also known as the life tenant, the right to occupy, possess or otherwise use the residential home for the lifetime of one or more individuals. As such, the life estate owner has a right to possess and use the residential home or shares therein for the duration of the life estate without any ownership interest. A remainderman has actual ownership interest in the residential home or shares therein, but has no right to possess or use the residential home until the life estate terminates. The system and method of the present invention is not a life estate and clearly does not include the limitations of a life estate. However, the use of the life estate tables does provide the present invention a means of objectively determining the value of the lifetime right of occupancy in the residential home or shares therein. The determined value of the lifetime right of occupancy is applied as a discount again the cost of purchasing ownership rights in the residential home or shared therein. The seller and the purchaser each understand the purpose for this discount, namely to price the residential home or shares therein in a manner that reflects the sellers continued occupancy the residential home after ownership has transferred to the purchaser.

The value of the life estate interest in the residential home or shares therein is calculated by multiplying the fair market value of the residential home or shares therein by a mortality figure corresponding to the age of the youngest leasee. The mortality figure is defined in a Life Estate Mortality Table referencing the age of the youngest leasee.

Once the life estate value of the residential home or shares therein has been calculated, the method of the present invention in step 106 then calculates the closing costs associated with the sale of the residential home or shares therein to the buyer. The closing costs may be calculated as a percentage of a gross amount received, this amount being defined as the determined fair market value of the residential home or shares therein minus the calculated life estate value of the same residential home or shares therein. Of course, a person of relative skill in the art will realize that the closing cost may be adjusted as needed to compensate for unforeseen expenses incurred in the purchase of the residential home or shares therein.

Once the closing costs have been calculated, the method of the present invention in step 107 then creates a housing expense trust which will finance annual housing expenses associated with the residential property or shares therein.

A trust is a legal agreement between three parties, namely a trustmaker, a trustee and a beneficiary. A trustmaker is the person who actually creates the trust. The trustee is the person or entity responsible for managing the assets that are titled to the trust. The beneficiary is the person or entity that receives the benefits of the assets titled to the trust. In other words, under this type of legal agreement, the trustmaker transfers ownership of certain assets to the trustee who will manage the assets for the benefit of the beneficiary.

In the present embodiment, the seller creates a trust and names a beneficiary. An independent trustee is also named for the trust. Specifically, the seller, as the trustmaker, creates the housing expense trust as a means to finance annualized housing expenses associated with the residential home or shares therein for the duration that the youngest leasee retains a lifetime right of occupancy after ownership has been transferred to the buyer. The named beneficiary of the housing expense trust will receive any funds remaining in the housing expense trust once the last youngest leasee has given up the right of occupancy in the residential home or shares therein.

Once the housing expense trust has been created, the method of the present invention in step 108 then calculates a pre-funding asset amount necessary to finance the housing expense trust. As discussed above, once the housing expense trust has been created and funded, the assets from the trust will be used to finance annual expenses associated with the residential home or shares therein over the duration of the youngest leasee's lifetime right of occupancy. The pre-funding asset amount defines the funds that will be titled to the housing expense trust by the seller once ownership has been transferred.

The pre-funding asset amount is calculated as the net-present value of annualized residential home or shares therein housing expenses across the duration of the calculated remaining life expectancy. The net present value of these annualized housing expenses is calculated at a defined discounted rate that represents a projected annualized rate of return of the housing expense trust. The mathematical formula for the net present value is

$$NPV = {\sum }_{i = 1}^{n} \frac{{values}_{i}}{{( 1 + rate )}^{i}} , where$$

$$n = term of the housing expense trust which is equal to calculated remaining life expectancy , {values}_{i} = annualized housing expenses for each year across the term of the housing expense trust , and$$

$$rate = defined rate of return of the housing expense trust .$$

The annualized housing expenses are calculated for each year for at least the term of the duration of the calculated remaining life expectancy. Each year is computed using thirteen months in order to create a reserve for unexpected expenses. The first year annualized expenses may include, but are not limited to, any number of relevant expenses including common charges fees, maintenance fees, real estate taxes, home taxes, home owner insurance fees, utility fees and maintenance fees. Of course, as a person of reasonable skill in the art will understand that the types and amounts of expense fees will vary depending on the type of residential home. The annualized housing expenses for each subsequent year is calculated as the sum of the immediate prior year's expenses plus an additional inflation amount.

The calculated net present value represents the amount needed to pre-fund the housing expense at a defined rate of return such that the totality of the funds within the housing expense trust at minimum are sufficient to cover the annualized housing expenses of the residential home or shares therein over the duration of the calculated remaining life expectancy.

Once the pre-funding asset amount needed to fund the housing expense trust has been calculated, the method of the present invention in step 109 then calculates a pre-tax unrestricted funds amount.

The pre-tax unrestricted funds are the funds the seller will actually receive from the buyer as consideration for the sale of the residential home or shares therein. The pre-tax unrestricted amount is defined as the fair market value of the residential home or shares therein minus the sum of the life estate value of the residential home or shares therein, any mortgages and liens held against the residential home or shares therein and the closing costs. The seller of the residential home or shares therein receives the pre-tax amount from the buyer and the seller then funds the housing expense trust using a portion of the received pre-tax unrestricted amount.

Once the pre-tax unrestricted funds amount has been calculated, the method of the present invention in step 110 then executes a contract between the buyer and the owner of the residential home or shares therein that immediately transfers ownership of the residential home or shares therein to the buyer. As consideration for this transfer of ownership, the executed contract provides for the owner to receive the above-described pre-tax unrestricted funds. The executed contract also providing the youngest leasee with a lifetime lease in the residential home during with annual housing expenses associated with the residential home or shares therein are paid from the assets within housing expense trust.

The execution of the contract for the sale of the residential home or shares therein effectively transfers ownership of the residential home or shares therein to the buyer. The seller does not retain any future ownership rights in the residential home or shares therein. The lifetime lease provided to the youngest leasee is a condition of the executed contract. The youngest leasee may be one or more persons including those with no present ownership rights in the residential home or shares therein. The fact that there is a complete transfer of ownership via the executed contract allows for the removal of many of the restrictions and limitations associated with existing forms of reverse mortgages and life estates. Some of the limitations removed by this embodiment of the present invention include those on the type of residential home such as cooperatives and condominiums as well as those on homes which are not primary residences. Moreover, any restrictions on the age of the homeowner, the sale price amount, income or other asset requirements as well as credit rating requirements are also removed.

Once the contract between the buyer and the current owner has been executed, the method of the present invention in step 111 then funds the housing expense trust with the calculated pre-funding asset amount. As previously discussed, the annual housing expenses associated with the residential home or shares therein are paid out of the assets within the housing expense trust. Once the last leasee dies or permanently vacates the residential home, the residential home or shares therein will be sold and the housing expense trust will be terminated. Any balance remaining in the housing expense trust will be provided to the beneficiary of the housing expense trust. The hosing expense trust having been established by the seller as an irrevocable trust having a beneficiary named by the seller.

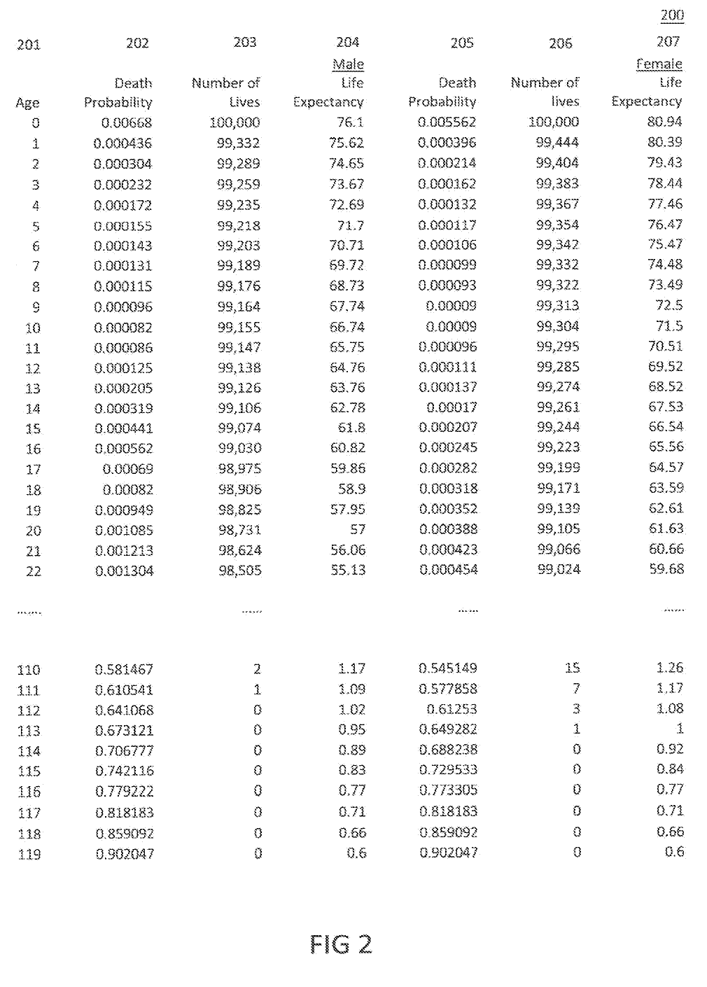

In FIG. 2, an exemplary depiction of a Period Life Table as implemented in the system and method for purchasing a residential home or shares therein according to an embodiment of the present invention is illustrated. As shown in FIG. 2, the Period Life Table 200 includes an age column 201 applicable to both males and females. The Period Life Table 200 further includes a death probability column 202, a number of lives column 203 and a life expectancy column 204 for males. Similarly, the Period Life Table includes a death probability column 205, a number of lives column 206 and a life expectancy column 207 for females. The information in the Period Life Table 200 shows the current probability of death, for people of different ages, in a current year. The Period Life Table 200 does not take into consideration any personal health information or lifestyle information.

The age columns 201 refers to the current age of a person whose probability of death within the current year is to be determined. The ages range from 0 to 119, samples of which are shown. In the present invention, this is the age of the youngest lease.

The death probability columns 202 and 205 refer to the probability of the person dying within one year. In the present invention, this is the probability that the youngest leasee will die within a year of the execution of the contract that transfer of ownership of the residential home or shares therein to the buyer.

The number of lives columns 203 and 206 refer to the number of survivors out of 100,000 born alive.

Lastly, the life expectancy columns 204 and 207 represent the average number of years of life remaining if a group of persons at that age were to experience the current mortality rates over the course of their remaining life.

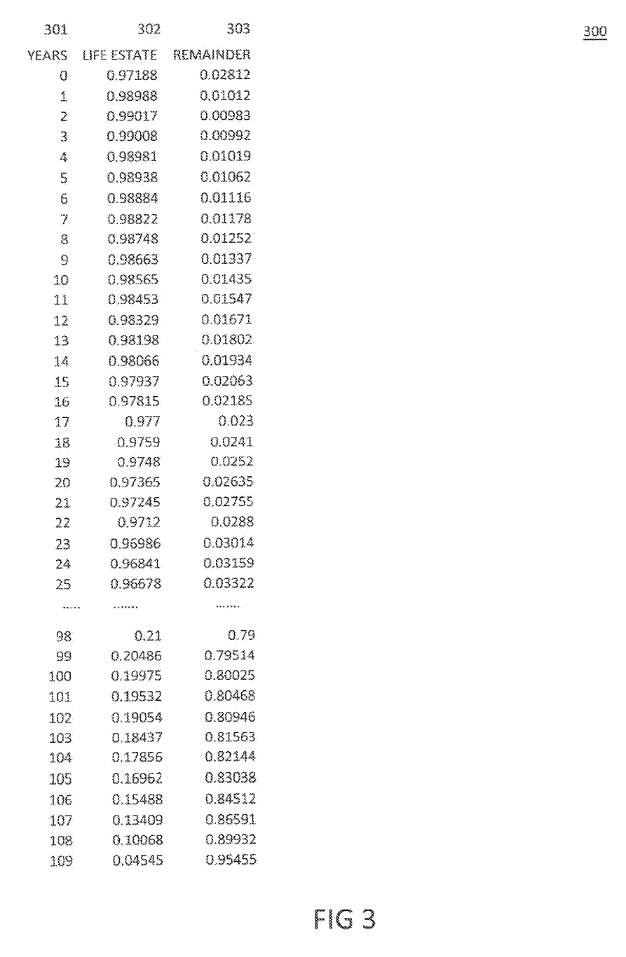

In FIG. 3, an exemplary depiction of a Life Estate or Remainder table implemented in the system and method for purchasing a residential home or shares therein according to an embodiment of the present invention is illustrated. A life Estate and Remainder Table is normally used to determine the value of a life estate or reminder interest held in a residential home or shares therein. As shown In FIG. 3, the Life Estate or Remainder Table 300 includes a years column 301, a life estate column 302 and a remainder column 303.

The years column 301 represent a person's age as of their last birthday. The ages range from 0 to 109, samples of which are shown in FIG. 3. In the present invention, this is the age of the youngest lease.

The life estate column 302 represent a number that is multiplied by the equity value of the residential home or shares therein to calculate the life estate interest of that residential home or shares therein. In the present invention, this number is multiplied by the fair market value of the residential home or shares therein.

The remainder column 303 represents a number that is multiplied by the equity value of the residential home or shares therein to calculate the remainder interest in that residential home or shares therein.

What is claimed is:

1. A method for purchasing a residential home or shares therein while providing a youngest leasee a lifetime right of occupancy, the method steps comprising:
determining a fair market value of the residential home or shares therein;
determining any mortgages or liens held against the residential home or shares therein;
determining the age and gender of the youngest leasee;
calculating a remaining life expectancy duration for the youngest leasee;
calculating a life estate value of the residential home or shares therein based on the age of the youngest leasee;
calculating closing costs associated with the purchase of the residential home or shares therein;
creating a housing expense trust;
calculating a pre-funding asset amount needed to fund the housing expense trust;
calculating a pre-tax unrestricted amount as a monetary consideration for the purchase of the residential home or shares therein;
executing a contract that executes the purchase of the residential home or shares therein for the monetary consideration, creates a lifetime lease for the youngest leasee in the residential home or shares therein and provide for the payment of annualized housing fees associated with the residential home or shares therein from assets within the housing expense trust; and
funding the housing expense trust with funds equal to the calculated pre-funding asset amount.

2. The method for purchasing a residential home or shares therein while providing a youngest leasee a lifetime right of occupancy of claim 1, wherein the fair market value is determined by a certified appraisal of the residential home or shares therein.

3. The method for purchasing a residential home or shares therein while providing a youngest leasee a lifetime right of occupancy of claim 1, wherein the life estate value is calculated using a unisex Life Estate or Remainder Table to determine a life estate factor and then multiplying the fair market value by the life estate factor.

4. The method for purchasing a residential home or shares therein while providing a youngest leasee a lifetime right of occupancy of claim 1, wherein the closing costs are calculated as a percentage of a gross received amount that is equal to the fair market value minus the life estate value.

5. The method for purchasing a residential home or shares therein while providing a youngest leasee a lifetime right of occupancy of claim 1, wherein the remaining life expectancy duration is calculated using a Period Life Table to determine a life expectance based on the age and gender of the youngest leasee and multiplying the life expectancy by a pre-defined right of occupancy adjustment factor.

6. The method for purchasing a residential home or shares therein while providing a youngest leasee a lifetime right of occupancy of claim 1, wherein the pre-funding asset amount is calculated as the net-present value of annualized residential home or shares therein expenses across the theoretical duration of the right of occupancy.

7. The method for purchasing a residential home or shares therein while providing a youngest leasee a lifetime right of occupancy of claim 6, wherein the annualized residential home or shares therein expenses are calculated for a first year and subsequent years are then calculated as an immediate prior year's annualized residential home or shares therein expenses with an additional inflation amount.

8. The method for purchasing a residential home or shares therein while providing a youngest leasee a lifetime right of occupancy of claim 6, wherein the annualized expenses may include one or more of the following fees, common charge fees, maintenance fees, real estate tax fees, residential home insurance fees, home owner insurance fees, utility fees and residential home maintenance fees.

9. The method for purchasing a residential home or shares therein while providing a youngest leasee a lifetime right of occupancy of claim 1, wherein the pre-tax amount is calculated as the fair market value minus the sum of the life estate value, the mortgages or liens held again the residential home or shares therein, the closing costs and the pre-funding amount.
